(19) United States
(12) Patent Application Publication
(10) Pub. No.: US 2026/0369462 A1
(43) Pub. Date: Nov. 19, 2026

(54) INDUCTOR STRUCTURE AND POWER MODULE USING THE SAME

(71) Applicant: Delta Electronics, Inc., Taoyuan City (TW)

(72) Inventors: Xueliang Chang, Shanghai (CN); Xingxin Zheng, Shanghai (CN)

(21) Appl. No.: 19/643,579

(22) Filed: Apr. 9, 2026

(30) Foreign Application Priority Data
May 15, 2025 (CN) 202510627398.X

(51) Int. Cl. H01F 27/29; H01F 27/24

(52) U.S. Cl. CPC H01F 27/292; H01F 27/24

(57) ABSTRACT

An inductor structure and a power module using the same are disclosed. The inductor structure includes a magnetic core, M first metal conductors, and N second metal conductors. The M first metal conductors pass through the magnetic core, each forming a first upper lead-out terminal and a first lower lead-out terminal, and being configured to form a winding. The N second metal conductors pass through the magnetic core, each forming a second upper lead-out terminal and a second lower lead-out terminal at a common potential. The M first metal conductors and the N second metal conductors are arranged alternately in a uniformly spaced matrix. A distance between each two adjacent first metal conductors is greater than a distance between each of the M first metal conductors and a corresponding adjacent second metal conductor, M and N are integers, M is at least 2 and N is at least 2.

### CROSS-REFERENCE TO RELATED APPLICATION

This application claims priority to China Patent Application No. 202510627398.X, filed on May 15, 2025. The entire contents of the above-mentioned patent application are incorporated herein by reference for all purposes.

### TECHNICAL FIELD

The present disclosure relates to the field of power electronics technology, and more particularly to an inductor structure and a power module using the same.

### BACKGROUND

With the rapid development and widespread application of microprocessors and communication equipment, the current flowing through the computing chips has increased rapidly, exceeding 1000 amperes. This change has brought great challenges to the voltage regulator that powers the chip.

Generally, the voltage regulators need to have characteristics such as low output voltage, high current, high load transient performance and high efficiency. In particular, the inductor is an indispensable and important component in the voltage regulator, and plays a vital role in the performance, the size and the cost of the voltage regulator.

A conventional inductor is constructed by windings passing through a magnetic core. Each winding is coupled to each other, which increases the maximum magnetic flux density and makes the magnetic core easily saturated. Moreover, the inductance of each winding output is difficult to balance, which is not conducive to the power module to achieve multi-channel parallel output. On the other hand, the magnetic flux inside the magnetic core is unevenly distributed, the loss of the magnetic core is large, and the total loop length from the inductor winding to the ground end is long, resulting in high loss. Thus, it is not conducive to improving the efficiency of the power module.

In view of this, there is a need of providing an inductor structure and a power module using the same, which includes a plurality of winding metal conductors and a plurality of grounding metal conductors embedded in a magnetic core and arranged alternately in a matrix to reduce the total loop length, whereby the loss is reduced, the efficiency is improved, and the problems of magnetic core saturation, uneven current sharing among windings and large loss are effectively solved.

### SUMMARY

An object of the present disclosure is to provide an inductor structure and a power module using the same, which includes a plurality of winding metal conductors and a plurality of grounding metal conductors embedded in a magnetic core and arranged alternately in a matrix to reduce the total loop length, whereby the loss is reduced, the efficiency is improved, and the problems of magnetic core saturation, uneven current sharing among windings and large loss are effectively solved.

Another object of the present disclosure is to provide an inductor structure and a power module using the same. A plurality of metal conductors are disposed in the magnetic core and partially exposed on at least one surface of the inductor structure. The plurality of metal conductors are divided into winding metal conductors and grounding metal conductors, which are arranged alternately with each other in a matrix. Moreover, the metal conductors disposed around and closest to each winding metal conductor are all grounding metal conductors. All winding metal conductors have one end connected to a switch device. The alternating arrangement design of the metal conductors can effectively reduce the coupling between the windings, improve the consistency of inductance, and significantly shorten the loop path between the windings and the ground, thereby reducing loss and improving conversion efficiency.

In accordance with an aspect of the present disclosure, an inductor structure is provided and includes a magnetic core, M first metal conductors, and N second metal conductors. The magnetic core includes an upper surface and a lower surface arranged opposite to each other. The M first metal conductors are disposed in the magnetic core, wherein the M first metal conductors pass through the magnetic core, and each of the M first metal conductors forms a first upper lead-out terminal on the upper surface and a first lower lead-out terminal on the lower surface, wherein each of the M first metal conductors is configured to form a winding. The N second metal conductors are disposed in the magnetic core, wherein the N second metal conductors pass through the magnetic core, and each of the N second metal conductors forms a second upper lead-out terminal on the upper surface and a second lower lead-out terminal on the lower surface, and the second upper lead-out terminals and the second lower lead-out terminals are at a common potential. The M first metal conductors and the N second metal conductors are arranged alternately in a uniformly spaced matrix, wherein a distance between each two adjacent first metal conductors is greater than a distance between each of the M first metal conductors and a corresponding adjacent second metal conductor, M and N are integers, and M is at least 2 and N is at least 2.

In accordance with another aspect of the present disclosure, a power module is provided and includes an inductor structure, a plurality of switch devices and a bottom circuit board. The inductor structure includes a magnetic core, M first metal conductors, and N second metal conductors. The magnetic core includes an upper surface and a lower surface arranged opposite to each other. The M first metal conductors are disposed in the magnetic core, wherein the M first metal conductors pass through the magnetic core, and each of the M first metal conductors forms a first upper lead-out terminal on the upper surface and a first lower lead-out terminal on the lower surface, wherein each of the M first metal conductors is configured to form a winding. The N second metal conductors are disposed in the magnetic core, wherein the N second metal conductors pass through the magnetic core, and each of the N second metal conductors forms a second upper lead-out terminal on the upper surface and a second lower lead-out terminal on the lower surface, wherein the second upper lead-out terminals and the second lower lead-out terminals are at a common potential. The M first metal conductors and the N second metal conductors are arranged alternately in a uniformly spaced matrix, a distance between each two adjacent first metal conductors is greater than a distance between each of the M first metal conductors and a corresponding adjacent second metal conductor, and M and N are integers, M is at least 2 and N is at least 2. The plurality of switch devices are disposed on the upper surface, wherein the plurality of switch devices are electrically connected to the first upper lead-out terminals and the second upper lead-out terminals. The bottom circuit board includes a ground terminal and an output terminal, wherein the first lower lead-out terminal is electrically connected to the output terminal, and the second lower lead-out terminal is electrically connected to the ground terminal.

The beneficial effect of the present disclosure is that the embodiments of the present disclosure provide an inductor structure and a power module using the same for solving the problems of magnetic core saturation, uneven current sharing among windings and large loss. A plurality of metal conductors running through the magnetic core are divided into winding metal conductors and grounding metal conductors, which are arranged alternately with each other in a matrix. Moreover, the metal conductors disposed around and closest to each winding metal conductor are all grounding metal conductors. All winding metal conductors have one end connected to a switch device. The alternating arrangement design of the metal conductors can effectively reduce the coupling between the windings, improve the consistency of inductance, and significantly shorten the loop path between the windings and the ground, thereby reducing losses and improving conversion efficiency.

### BRIEF DESCRIPTION OF THE DRAWINGS

FIG. 1 schematically shows an entire appearance of an inductor structure according to an embodiment of the present disclosure from an upper perspective;

FIG. 2 schematically shows the entire appearance of the inductor structure according to the embodiment of the present disclosure from a lower perspective;

FIG. 3 schematically shows the plurality of metal conductors of the inductor structure alternately arranged in a uniformly spaced matrix according to the embodiment of the present disclosure;

FIG. 4 is a cross-sectional view showing the lead-out terminals of the inductor structure electrically connected by shorting according to the embodiment of the present disclosure;

FIG. 5 is a circuit diagram illustrating the inductor structure applied to a power module according to the embodiment of the present disclosure;

FIG. 6 schematically shows the magnetic flux distribution in the inductor structure according to the embodiment of the present disclosure;

FIG. 7 schematically shows an entire appearance of the power module according to an embodiment of the present disclosure;

FIG. 8 is an exploded structural view of the power module of FIG. 7 from an upper perspective;

FIG. 9 is an exploded structural view of the power module of FIG. 7 from a lower perspective;

FIG. 10 is a cross-sectional view illustrating the power module of FIG. 7;

FIG. 11 schematically shows an overall appearance of a power module according to another embodiment of the present disclosure;

FIG. 12 is an exploded structural view of the power module of FIG. 11 from an upper perspective;

FIG. 13 is an exploded structural view of the power module of FIG. 11 from a lower perspective; and

FIG. 14 is a cross-sectional view illustrating the power module of FIG. 11.

### DETAILED DESCRIPTION

The present disclosure will now be described more specifically with reference to the following embodiments. It is to be noted that the following descriptions of embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals or letters in the various examples. This repetition is for the purpose of simplicity and clarity and does not in itself dictate a relationship between the various embodiments or configurations discussed. Further, spatially relative terms, such as “upper,” “lower,” “top,” “bottom” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the "first," "second," and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments. Besides, "and / or" and the like may be used herein for including any or all combinations of one or more of the associated listed items. Alternatively, the word "about" means within an acceptable standard error of ordinary skill in the art-recognized average. In addition to the operation / working examples, or unless otherwise specifically stated otherwise, in all cases, all of the numerical ranges, amounts, values and percentages, such as the number for the herein disclosed materials, time duration, temperature, operating conditions, the ratio of the amount, and the like, should be understood as the word "about" or "substantially" decorator. Accordingly, unless otherwise indicated, the numerical parameters of the present disclosure and scope of the appended patent proposed is to follow changes in the desired approximations. At least, the number of significant digits for each numerical parameter should at least be reported and explained by conventional rounding technique is applied. Herein, it can be expressed as a range between from one endpoint to the other or both endpoints. Unless otherwise specified, all ranges disclosed herein are inclusive.

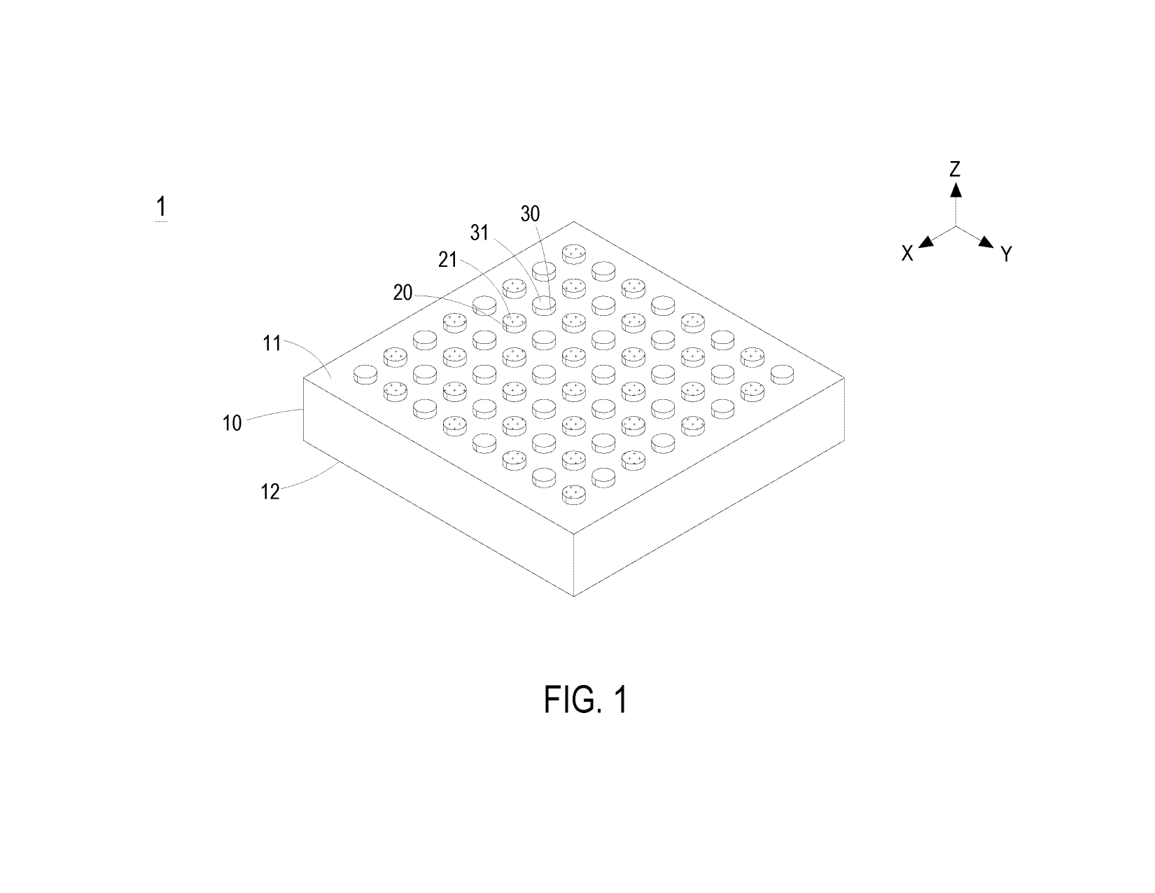

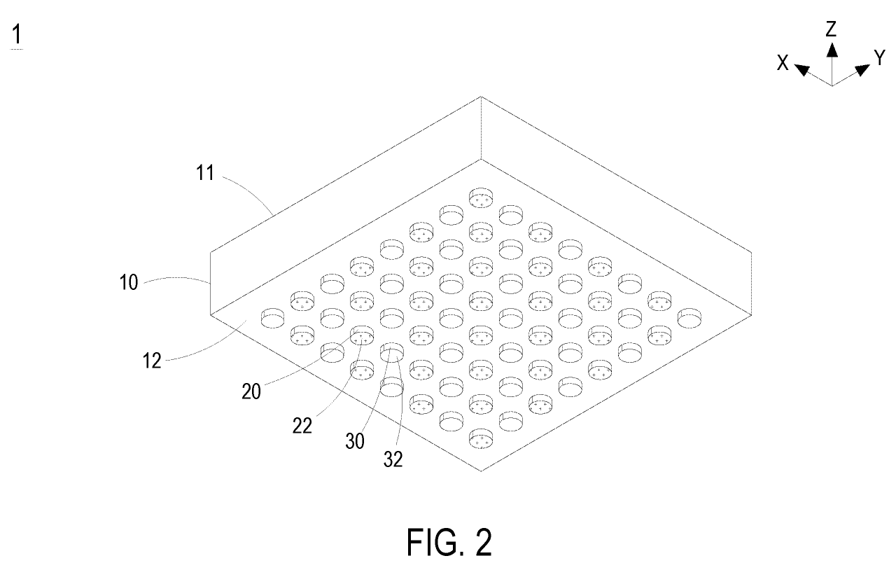

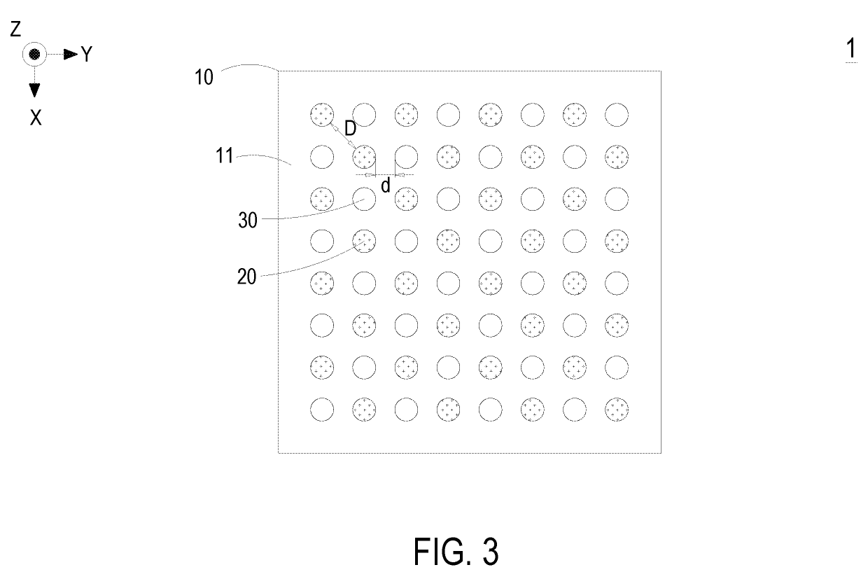

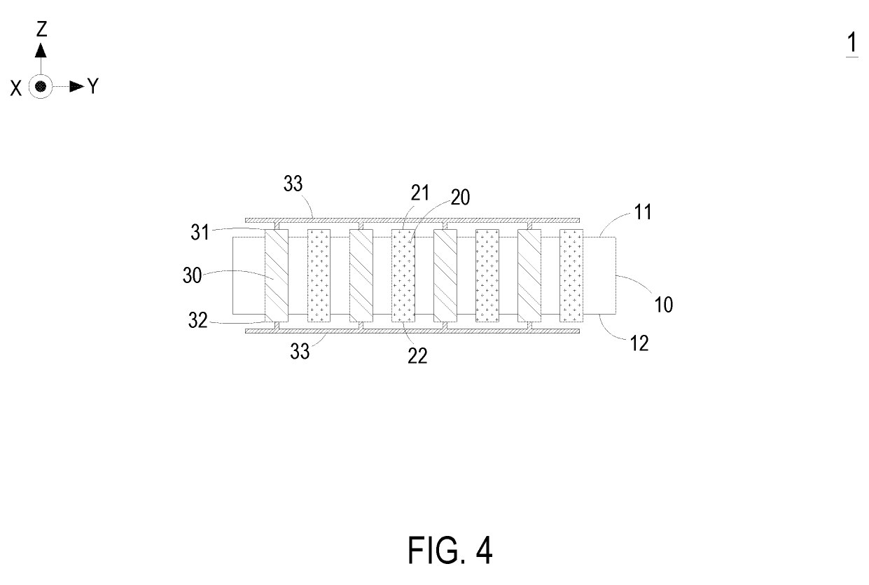

FIGS. 1 and 2 schematically show an entire appearance of an inductor structure according to an embodiment of the present disclosure. FIG. 3 schematically shows the plurality of metal conductors of the inductor structure alternately arranged in a uniformly spaced matrix according to the embodiment of the present disclosure. FIG. 4 is a cross-sectional view showing the lead-out terminals of the inductor structure electrically connected by shorting according to the embodiment of the present disclosure. In order to solve the problems of magnetic core saturation, uneven current sharing among windings and large loss when an inductor structure is applied to a power module, the present disclosure provides an inductor structure 1 with a matrix arrangement. The inductor structure 1 includes a magnetic core 10, M first metal conductors 20, and N second metal conductors 30. The magnetic core 10 includes an upper surface 11 and a lower surface 12 arranged opposite to each other. The M first metal conductors 20 are disposed in the magnetic core 10. Furthermore, the M first metal conductors 20 pass through the magnetic core 10. Each of the M first metal conductors 20 forms a first upper lead-out terminal 21 on the upper surface 11 and a first lower lead-out terminal 22 on the lower surface 12, and each of the M first metal conductors 20 is configured to form a winding. In the embodiment, the N second metal conductors 30 are disposed in the magnetic core 10. Furthermore, the N second metal conductors 30 pass through the magnetic core 10. Each of the N second metal conductors 30 forms a second upper lead-out terminal 31 on the upper surface 11 and a second lower lead-out terminal 32 on the lower surface 12, and the second upper lead-out terminals 31 and the second lower lead-out terminals 32 are at a common potential. In the embodiment, the M first metal conductors 20 and the N second metal conductors 30 are arranged alternately with each other in a uniformly spaced matrix, M and N are integers, M is at least 2 and N is at least 2. In some embodiments, M and N can be equal.

In the embodiment, the magnetic core 10 is made of ferrite or other low-loss soft magnetic materials. In addition, the M first metal conductors 20 and the N second metal conductors 30 are all metal pillars with an identical structure, such as metal copper pillars. The M first metal conductors 20 and the N second metal conductors 30 vertically extend from the upper surface 11 to the lower surface 12 of the magnetic core 10. Notably, the M first metal conductors 20 and the N second metal conductors 30 not only have the identical structure, but are also arranged in a uniformly spaced matrix. In one embodiment, the plurality of metal pillars with the same structure are arranged in a uniformly spaced square matrix, vertically extend from the upper surface 11 to the lower surface 12 of the magnetic core 10, and then respectively divided into the first metal conductors 20 and the second metal conductors 30 for use. The N second metal conductors 30 vertically extend from the upper surface 11 to the lower surface 12 of the magnetic core 10 can be directly electrically connected to each other through shorting of a common line 33 on the upper surface 11 or the lower surface 12 of the magnetic core 10 to form the common potential for grounding. It should be noted that the first metal conductors 20 and the second metal conductors 30 are substantially identical in structure, allowing for minor manufacturing tolerances or variations that do not affect their overall function.

In the embodiment, the M first metal conductors 20 and the N second metal conductors 30 are arranged alternately, and a distance D formed between each adjacent two of the M first metal conductors 20 is greater than a distance d formed between each of the M first metal conductors 20 and a corresponding adjacent second metal conductor 30. In this way, four sides of each first metal conductor 20 are disposed adjacent to the second metal conductor 30. That is, when the M first metal conductors 20 are used as windings, the nearest neighboring metal conductor of each winding metal conductor is a grounding metal conductor. Through the alternating arrangement of the plurality of metal conductors with the same structure, the coupling between windings can be effectively reduced, the consistency of inductance can be improved, and the loop path between the winding and the ground can be significantly shorten, thereby reducing loss and improving conversion efficiency. It will be further explained later.

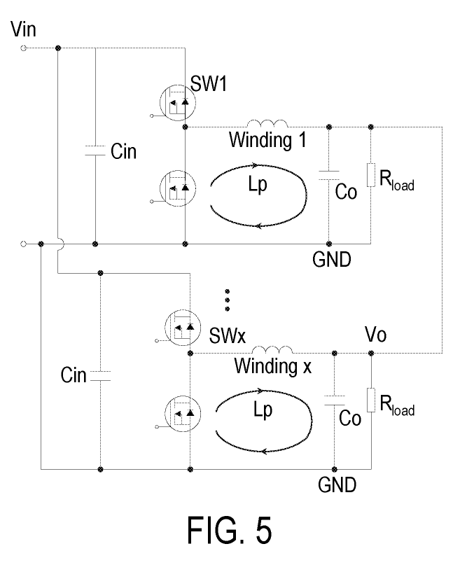

FIG. 5 is a circuit diagram illustrating the inductor structure applied to a power module according to the embodiment of the present disclosure. Please refer to FIGS. 1 to 5. In the embodiment, when the inductor structure 1 of the present disclosure is applied to a circuit of a power module such as shown in FIG. 5, the M first metal conductors 20 can form a plurality of windings (Winding 1~Winding x), which are connected in parallel with each other. The first upper lead-out terminals 21 and the first lower lead-out terminal 22 of the M first metal conductors 20 are respectively configured to form two connection ends of the plurality of windings (Winding 1~Winding x). The second upper lead-out terminals 31 and the second lower lead-out terminals 32 of the N second metal conductors 30 are all at the common potential and used to connect to the ground terminal GND. In the embodiment, a plurality of switch devices SW1~SWx, such as DrMOS, can be arranged on the upper surface 11 of the magnetic core 10, and are respectively connected to the first upper lead-out terminals 21 of the M first metal conductors 20 served as the plurality of windings (Winding 1~Winding x) and the second upper lead-out terminals 31 of the N second metal conductors 30, and then an input voltage Vin and an input capacitor Cin are further combined therewith. In that, the circuit design on the left side of FIG. 5 is constructed. On the other hand, the first lower lead-out terminal 22 and the second lower lead-out terminal 32 formed on the lower surface 12 of the magnetic core 10 can be electrically connected to a ground terminal GND, an output capacitor Co, a load R_{load}and an output voltage Vo, etc., so that the circuit design on the right side of FIG. 5 is constructed.

Notably, in the embodiment, the M first metal conductors 20 and the N second metal conductors 30 of the inductor structure 1 are the plurality of metal conductors with the identical structure that vertically extend from the upper surface 11 to the lower surface 12 of the magnetic core 10. Moreover, each of the M first metal conductors 20 is respectively led out of the upper surface 11 and the lower surface 12 in the shortest distance through the first upper lead-out terminal 21 and the first lower lead-out terminal 22. Each of second metal conductors 30 is respectively led out of the upper surface 11 and the lower surface 12 in the shortest distance through the second upper lead-out terminal 31 and the second lower lead-out terminal 32. In addition, in the embodiment, the plurality of windings (Winding 1~Winding x) formed by the M first metal conductors 20 of the inductor structure 1 and the multiple ground terminals GND connected to the N second metal conductors 30 further form a loop Lp when the inductor structure 1 is used in conjunction with the plurality of switch devices SW1~SWx and the output capacitor Co, as shown in FIG. 5. In inductor design, the shorter the loop Lp, the lower the loss. In particular, since a large current will be generated between the winding and the ground terminal GND when the circuit is working, the shorter the path of the winding to the ground, the lower the loss, whereby the quality of the inductor can be greatly improved.

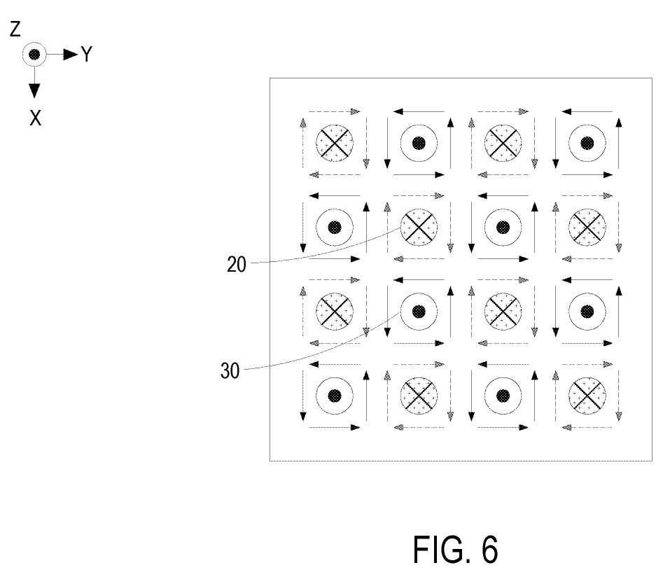

FIG. 6 schematically shows the magnetic flux distribution in the inductor structure according to the embodiment of the present disclosure. In the inductor structure 1 used in the power module, the M first metal conductors 20 served as the windings and the N second metal conductors 30 served as grounding are arranged alternately, vertically passing through the magnetic core 10, and led out of the upper surface 11 and the lower surface of the magnetic core 10 in the shortest path. Furthermore, the metal conductor closest to each first metal conductor 20 is the second metal conductor 30. In the embodiment, a current direction of the M first metal conductors 20 is opposite to a current direction of the N second metal conductors 30. When the M first metal conductors 20 are served as the winding metal conductors and the current flows along the reverse Z axial direction (for example, the direction perpendicular to the paper and inward), each first metal conductor 20 will generate a magnetic flux in the clockwise direction. When the N second metal conductors 30 are served as the grounding metal conductors and the current flows along the Z axial direction (for example, the direction perpendicular to the paper and outward), each second metal conductor 30 will generate a magnetic flux in a counterclockwise direction. In this way, the metal conductors closest to the four sides of each winding metal conductor (first metal conductor 20) at a distance d are all grounding metal conductors (second metal conductors 30), and the mutually coupled magnetic flux directions help stabilize the magnetic flux within the winding metal conductor. Each winding metal conductor (the first metal conductor 20) and the nearest adjacent winding metal conductor (the first metal conductor 20) at a distance D are isolated by the grounding metal conductors (the second metal conductors 30) therebetween, thereby preventing coupling with each other and causing the magnetic core 10 to be saturated. In other words, the coupling between adjacent winding metal conductors (the first metal conductors 20) is minimized through the design of the inductor structure 1 of the present disclosure. Moreover, it ensures the balance of inductance between each winding metal conductor (the first metal conductor 20). It facilitates the parallel output of power modules. Furthermore, the alternating arrangement of the M winding metal conductors (the first metal conductors 20) and the N grounding metal conductors (the second metal conductors 30) can reduce the total loop length therebetween, thereby reducing loss and improving efficiency. In other words, the application of the inductor structure 1 in the power module is more conducive to achieving the requirements of short loop and low loss. Certainly, the application of the inductor structure 1 of the present disclosure is not limited thereto.

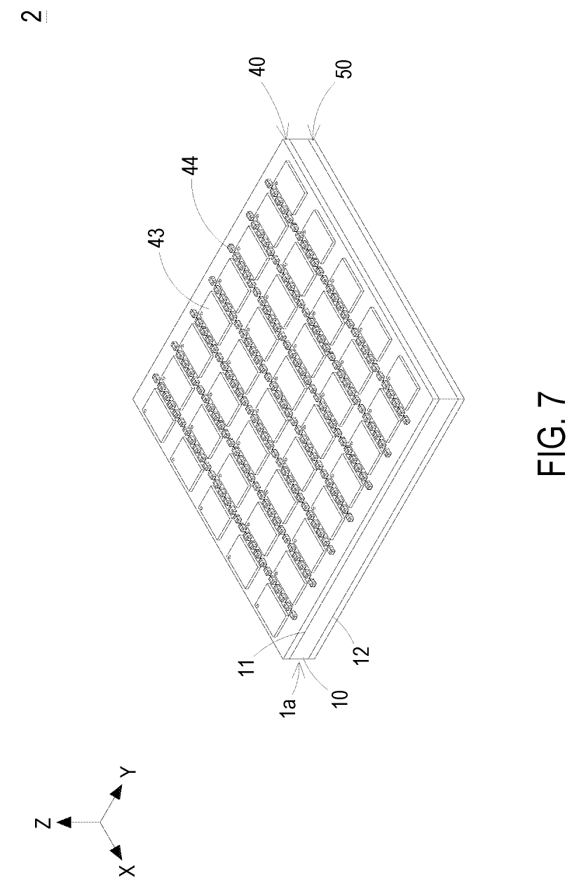

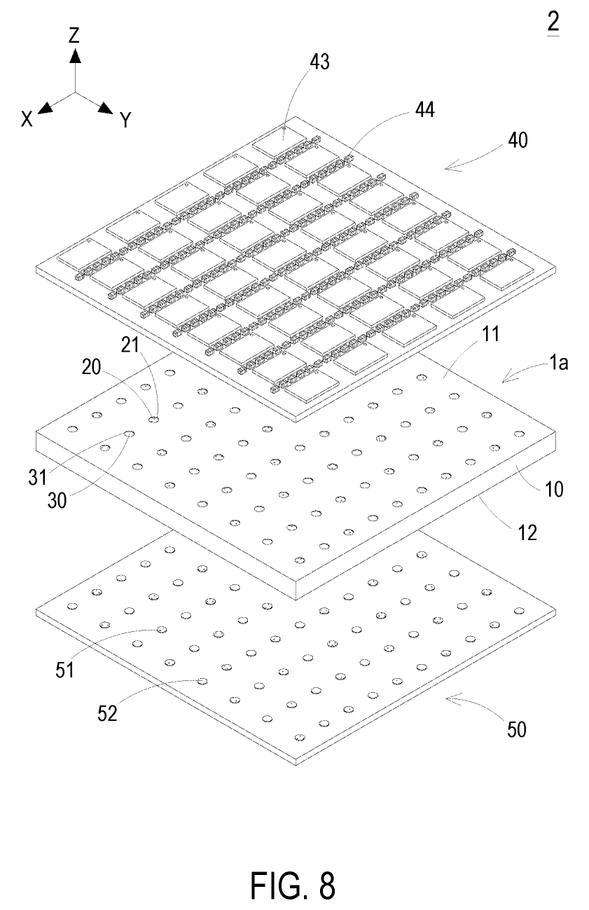

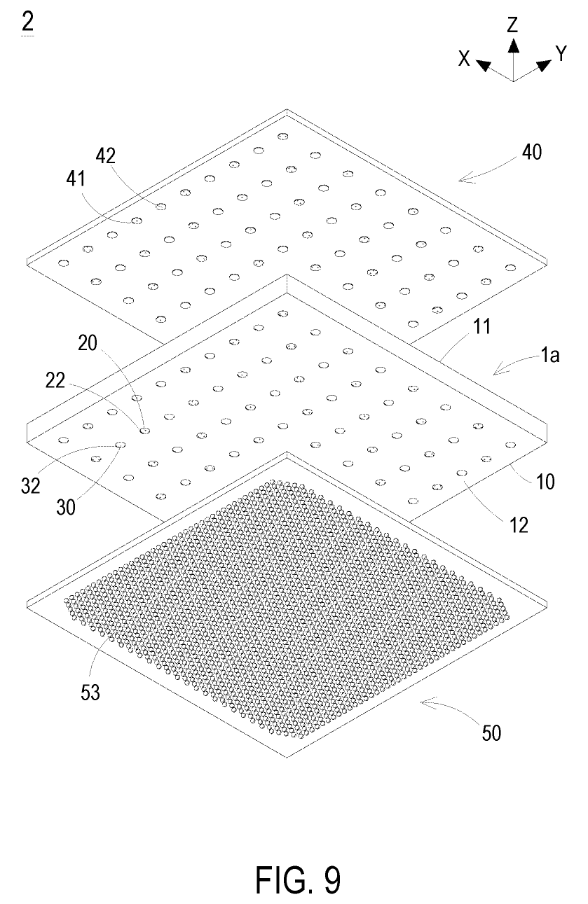

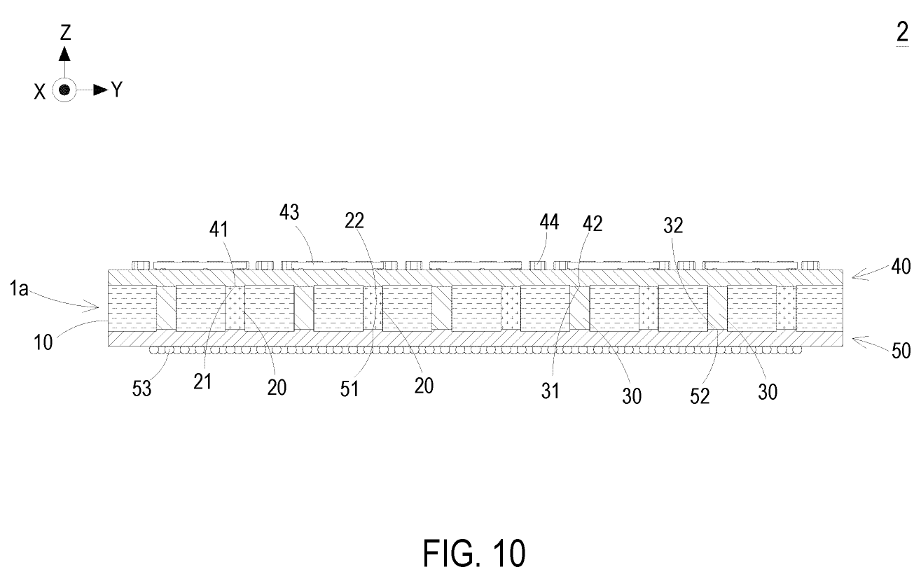

FIGS. 7 to 10 schematically show a power module according to an embodiment of the present disclosure. In the embodiment, the structures, elements and functions of the inductor structure 1a are similar to those of the inductor structure 1 of FIGS. 1 to 4, and are not redundantly described herein. In the embodiment, an upper circuit board 40 and a lower circuit board 50 are disposed on the upper surface 11 and the lower surface 12 of the inductor structure 1a, respectively. The upper circuit board 40 is disposed above the inductor structure 1a and electrically connected to the inductor structure 1a, and the lower circuit board 50 is disposed below the inductor structure 1a and electrically connected to the inductor structure 1a, so as to form a power module 2 suitable for the inductor structure 1a.

In the embodiment, the M first metal conductors 20 and the N second metal conductors 30 with the identical structure are alternately arranged and vertically extend from the upper surface 11 to the lower surface 12 of the magnetic core 10. In the embodiment, the M first metal conductors 20 are configured to form the windings. Each first upper lead-out terminal 21 is electrically connected to the copper-plated via 41 of the upper circuit board 40, and each first lower lead-out terminal 22 is electrically connected to the copper-plated via 51 of the lower circuit board 50.

In the embodiment, the N second metal conductors 30 are grounded to form the common potential. Each second upper lead-out terminal 31 is electrically connected to the copper-plated via 42 of the upper circuit board 40, and each second lower lead-out terminal 32 is electrically connected to the copper-plated via 52 of the lower circuit board 50. Compared with the aforementioned embodiment in which the N second metal conductors 30 are directly electrically connected on the upper surface 11 or the lower surface 12 by shorting, the N second metal conductors 30 of this embodiment are electrically connected to each other through wiring traces or the copper-plated vias 42 of the upper circuit board 40 and the copper-plated vias 52 of the lower circuit board 50. Certainly, the method of equally grounding the N second metal conductors 30 is adjustable according to the practical requirements, and the present disclosure is not limited thereto.

In some embodiments of the disclosure, the power module 2 is configured to form the power module circuit shown in FIG. 5. The inductor structure 1a provides the windings and the grounded components between the output terminals and the switch devices. The power module 2 further includes a plurality of switch device 43 and a plurality of input capacitors 44 corresponding to the plurality of switch devices SW1~SWx and the plurality of input capacitors Cin in FIG. 5. In some embodiments of the disclosure, the plurality of switch devices 43 and the plurality of input capacitors 44 are arranged on the surface of the upper circuit board 40 away from the inductor structure 1a, and electrically connected to the first upper lead-out terminals 21 of the M first metal conductors 20 and the second upper lead-out terminals 31 of the N second metal conductors 30 through the wiring traces or the copper-plated via 41, 42 of the upper circuit board 40. In other embodiments, the lower circuit board 50 further includes components corresponding to the output capacitor Co or the load R_{load} in FIG. 5, which are electrically connected to the first lower lead-out terminals 22 of the M first metal conductors 20 and the second lower lead-out terminals 32 of the N second metal conductors 30. The present disclosure is not limited thereto.

In the embodiment, the lower circuit board 50 further includes a plurality of solder balls 53 disposed on a surface of the lower circuit board 50 away from the inductor structure 1a. The wiring traces or the copper-plated vias 51, 52 of the lower circuit board 50 are connected to the first lower lead-out terminals 22 of the M first metal conductors 20 and the second lower lead-out terminals 32 of the N second metal conductors 30. In other embodiments, the power module 2 is further electrically connected to other loads, a motherboard or a signal circuit by disposing a plurality of solder balls 53 on the surface of the lower circuit board 50, thereby realizing multiple applications of the power module 2. Certainly, the number of electronic devices added to the upper circuit board 40 and the lower circuit board 50 can be adjusted according to the practical requirements, and the present disclosure is not limited thereto.

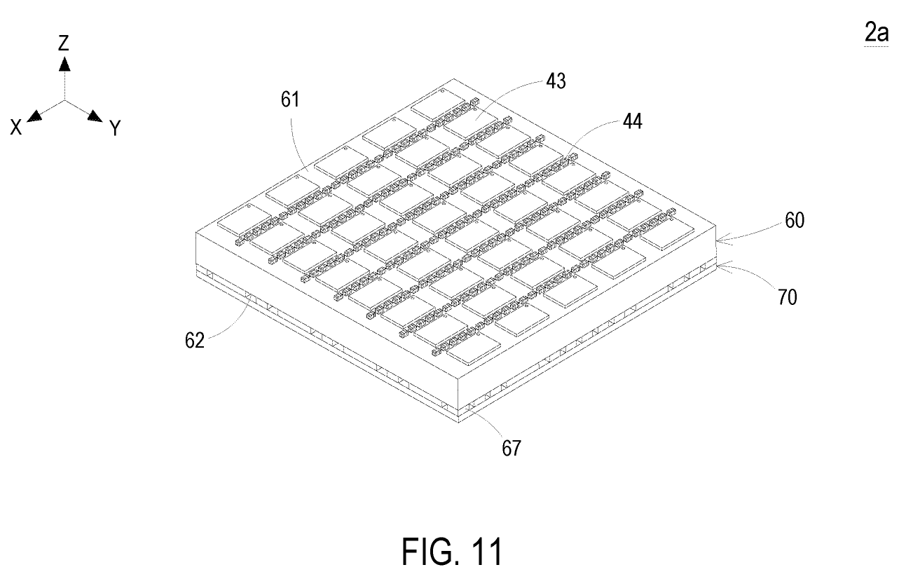

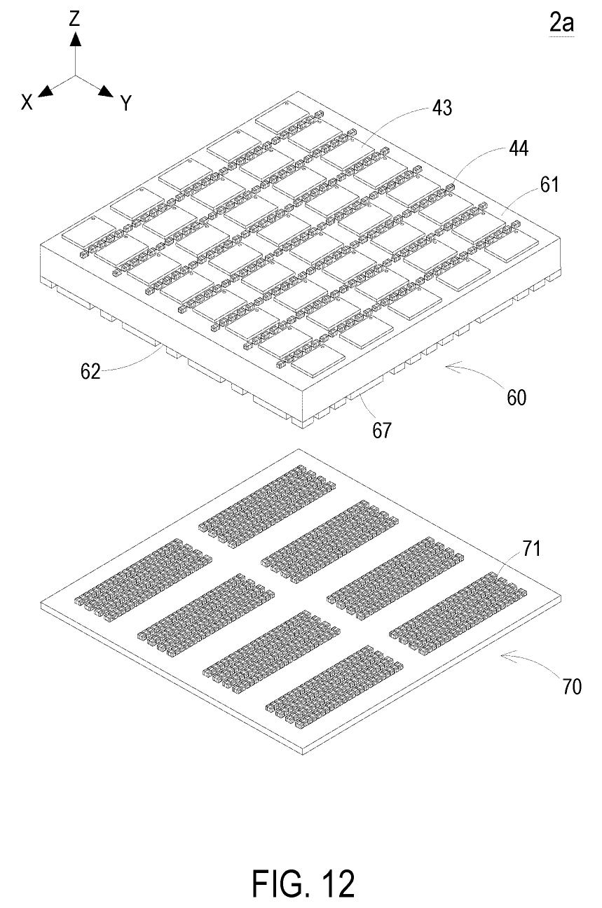

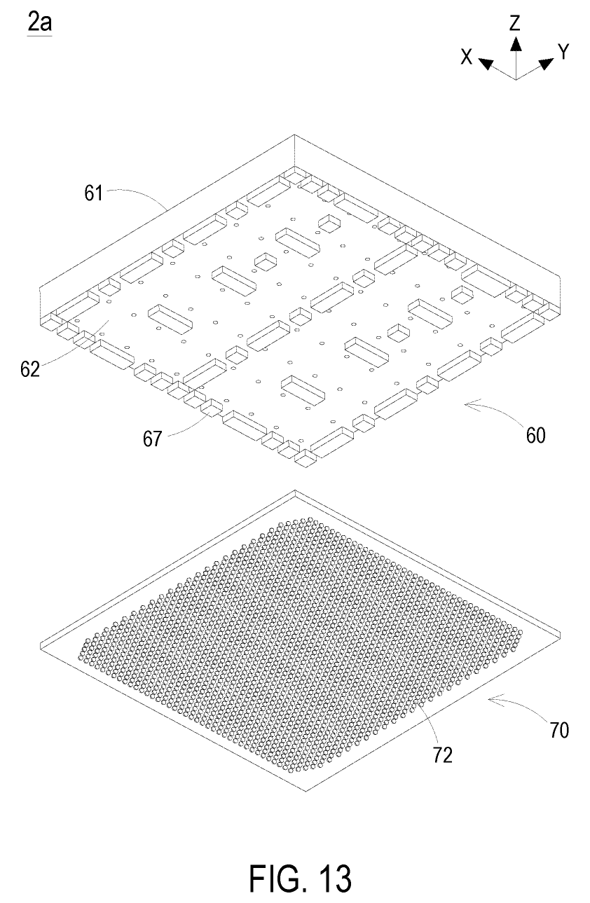

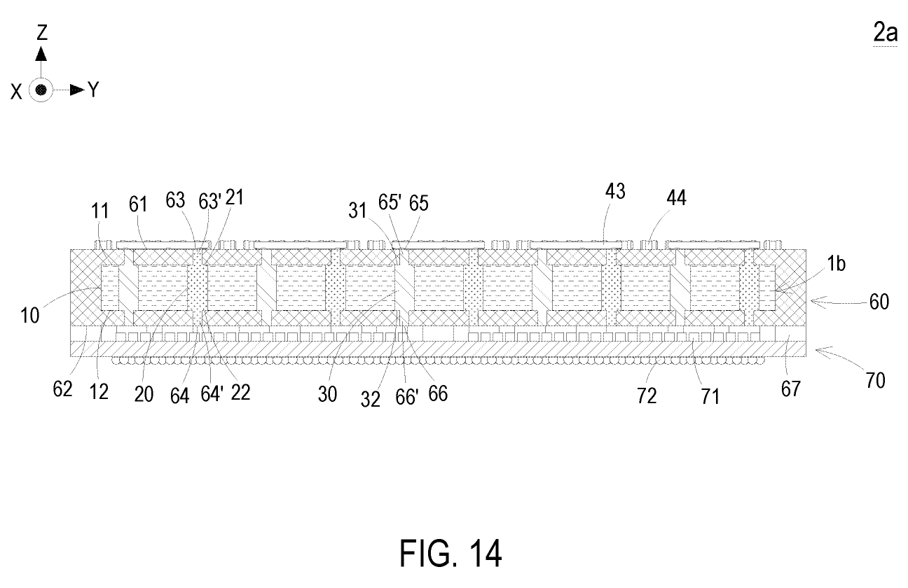

FIGS. 11 to 14 schematically show a power module according to another embodiment of the present disclosure. In the embodiment, the structures, elements and functions of the power module 2a and the inductor structure 1b are similar to those of the power module 2 and the inductor structure 1a of FIGS. 7 to 10, and are not redundantly described herein. In the embodiment, the power module 2 includes a main circuit board 60 having an inductor structure 1b, a plurality of switch devices 43, and a bottom circuit board 70. The magnetic core 10 of the inductor structure 1b is disposed in the main circuit board 60. The main circuit board 60 includes a top surface 61 and a bottom surface 62. The top surface 61 of the main circuit board 60 is spatially corresponding to the upper surface 11 of the magnetic core 10, and the bottom surface 62 of the main circuit board 60 is spatially corresponding to the lower surface 12 of the magnetic core 10. The M first metal conductors 20 and the N second metal conductors 30 vertically extend from the upper surface 11 to the lower surface 12 of the magnetic core 10. Each first upper lead-out terminal 21 of the M first metal conductors 20 forms a first upper soldering pad 63 on the top surface 61 through a copper-plated via 63' of the main circuit board 60. Each first lower lead-out terminal 22 of the M first metal conductors 20 forms a first lower soldering pad 64 on the bottom surface 62 through a copper-plated via 64' of the main circuit board 60. In addition, each second upper lead-out terminal 31 of the N second metal conductors 30 forms a second upper soldering pad 65 on the top surface 61 through a copper-plated via 65' of the main circuit board 60. Each second lower lead-out terminal 32 of the N second metal conductors 30 forms a second lower soldering pad 66 on the bottom surface 62 through a copper-plated via 66' of the main circuit board 60.

In the embodiment, the top surface 61 of the main circuit board 60 provides a first upper soldering pad 63 and a second upper soldering pad 65 for external electronic devices, and the bottom surface 62 of the main circuit board 60 provides a first lower soldering pad 64 and a second lower soldering pad 66 for external electronic devices and/or a bottom circuit board 70. In some embodiments, the power module 2a is configured to form the power module circuit shown in FIG. 5. The inductor structure 1b disposed in the main circuit board 60 provides the M first metal conductors 20 served as the plurality of windings (Winding 1~Winding x) shown in FIG. 5. The power module 2a includes a plurality of switch devices 43 and a plurality of input capacitors 44 corresponding to the plurality of switch devices SW1~SWx and the plurality of input capacitors Cin in FIG. 5. The plurality of switch devices 43 and the plurality of input capacitors 44 are disposed on the top surface 61 of the main circuit board 60, and the first upper soldering pad 63 and the second upper soldering pad 65 are electrically connected to the M first metal conductors 20 and the N second metal conductors 30 of the inductor structure 1b. In the embodiment, each first upper lead-out terminal 21 of the M first metal conductors 20 is electrically connected to at least two switch devices 43. The plurality of input capacitors 44 disposed on the top surface 61 are electrically connected to the switch devices 43, so as to form the connection between the plurality of switch devices SW1~SWx and the plurality of input capacitors Cin as shown in FIG. 5.

In some embodiments, the first lower soldering pad 64 and the second lower soldering pad 66 on the bottom surface 62 of the main circuit board 60 are used to connect the ground terminal GND, the output terminal of the output voltage Vo, the output capacitor Co and the load R_{load} shown in FIG. 5. In some embodiments, the output capacitor Co is an output capacitor 71 disposed on the bottom circuit board 70. The main circuit board 60 and the bottom circuit board 70 are connected via connectors 67. In other embodiments, the power module 2a includes a plurality of output capacitors 71 and/or a plurality of loads disposed between the bottom surface 62 of the main circuit board 60 and the bottom circuit board 70, and the plurality of output capacitors 71 and/or the plurality of loads are electrically connected to the bottom circuit board 70. In the embodiment, the power module 2a further includes a plurality of solder balls 72 disposed on a surface of the bottom circuit board 70 away from the inductor structure 1b. In some embodiments, the bottom circuit board 70 is further electrically connected to a motherboard, a signal circuit or a load R_{load} as shown in FIG. 5 through the surface with the plurality of solder balls 72 disposed thereon. Moreover, in the embodiment, the bottom circuit board 70 further includes a ground terminal GND and an output terminal for outputting the output voltage Vo as shown in FIG. 5. In the embodiment, each first upper lead-out terminal 21 of the M first metal conductors 20 served as the winding metal conductors can be electrically connected to an output terminal of the bottom circuit board 70 through the first lower soldering pad 64 on the bottom surface 62 of the main circuit board 60. In one embodiment, each of the first lower lead-out terminals 22 is electrically connected to at least one output terminal of the output voltage Vo. In another embodiment, each first lower outlet terminal 22 can also be electrically connected to each other through a wiring trace or a copper-plated via 64' on the main circuit board 60. Furthermore, each second lower lead-out terminal 32 of the N second metal conductors 30 served as the grounding metal conductors is electrically connected to a ground terminal of the bottom circuit board 70. In one embodiment, the N second metal conductors 30 are electrically connected to each other through the wiring traces or copper-plated vias 65', 66' of the main circuit board 60 to achieve grounding.

In the embodiment, the main circuit board 60 is a power board for transmitting power, and the bottom circuit board 70 is an output circuit board electrically connected to the output capacitor 71, the load, the motherboard or the signal circuit. Notably, in the design of the inductor structure 1b of the present disclosure, the plurality of winding metal conductors and the plurality of grounding metal conductors are arranged alternately, and it helps to solve the problems of core saturation, uneven current sharing among winding and large loss. Furthermore, by embedding the inductor structure 1b in the main circuit board 60, the purpose of improving the power density and conversion efficiency in a compact structure is achieved. Certainly, the present disclosure is not limited thereto and not redundantly described hereafter.

In summary, the present disclosure provides an inductor structure and a power module using the same, which includes a plurality of winding metal conductors and a plurality of grounding metal conductors embedded in a magnetic core and arranged alternately in a matrix to reduce the total loop length, whereby the loss is reduced, the efficiency is improved, and the problems of magnetic core saturation, uneven current sharing among windings and large loss are effectively solved. A plurality of metal conductors are disposed through the magnetic core and partially exposed on at least one surface of the inductor structure. The plurality of metal conductors are divided into winding metal conductors and grounding metal conductors, which are arranged alternately with each other in a matrix. Moreover, the metal conductors disposed around and closest to each winding metal conductor are all grounding metal conductors. All winding metal conductors have one end connected to a switch device. The alternating arrangement design of the metal conductors can effectively reduce the coupling between the windings, improve the consistency of inductance, and significantly shorten the loop path between the windings and the ground, thereby reducing losses and improving conversion efficiency.

It is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An inductor structure, comprising:
a magnetic core, comprising an upper surface and a lower surface arranged opposite to each other;
M first metal conductors disposed in the magnetic core, wherein the M first metal conductors pass through the magnetic core, and each of the M first metal conductors forms a first upper lead-out terminal on the upper surface and a first lower lead-out terminal on the lower surface, wherein each of the M first metal conductors is configured to form a winding; and
N second metal conductors disposed in the magnetic core, wherein the N second metal conductors pass through the magnetic core, and each of the N second metal conductors forms a second upper lead-out terminal on the upper surface and a second lower lead-out terminal on the lower surface, wherein the second upper lead-out terminals and the second lower lead-out terminals are at a common potential;
wherein the M first metal conductors and the N second metal conductors are arranged alternately in a uniformly spaced matrix, wherein a distance between each two adjacent first metal conductors is greater than a distance between each of the M first metal conductors and a corresponding adjacent second metal conductor, M and N are integers, and M is at least 2 and N is at least 2.

2. The inductor structure according to claim 1, wherein the M first metal conductors and the N second metal conductors vertically extend from the upper surface to the lower surface.

3. The inductor structure according to claim 2, wherein the M first metal conductors and the N second metal conductors are metal pillars with an identical structure.

4. The inductor structure according to claim 1, wherein the N second metal conductors are directly electrically connected on the upper surface or the lower surface by shorting.

5. The inductor structure according to claim 1, wherein an upper circuit board is disposed above the inductor structure and electrically connected to the inductor structure, a lower circuit board is disposed below the inductor structure and electrically connected to the inductor structure, and the N second metal conductors are electrically connected to each other through wiring traces or copper-plated vias of the upper circuit board and the lower circuit board.

6. The inductor structure according to claim 1, wherein the magnetic core is disposed in a main circuit board, and the N second metal conductors are electrically connected to each other through wiring traces or copper-plated vias of the main circuit board.

7. The inductor structure according to claim 6, wherein the main circuit board comprises a top surface and a bottom surface, the top surface is spatially corresponding to the upper surface, the bottom surface is spatially corresponding to the lower surface, the M first metal conductors and the N second metal conductors vertically extend from the upper surface to the lower surface, each of the first upper lead-out terminals forms a first upper soldering pad on the top surface through a copper-plated via, each of the second upper lead-out terminals forms a second upper soldering pad on the top surface through a copper-plated via, and the first upper soldering pad and the second upper soldering pad are electrically connected to a switch device.

8. The inductor structure according to claim 7, wherein each of the first lower lead-out terminals forms a first lower soldering pad on the bottom surface through a copper-plated via, each of the second lower lead-out terminals forms a second lower soldering pad on the bottom surface through a copper-plated via, and the first lower soldering pad and the second lower soldering pad are configured to be directly soldered to a bottom circuit board.

9. The inductor structure according to claim 8, wherein the main circuit board is a power board for transmitting power, and the bottom circuit board is an output circuit board electrically connected to an output capacitor, a load, a motherboard or a signal circuit.

10. The inductor structure according to claim 6, wherein each of the first lower lead-out terminals is electrically connected to each other through a wiring trace or a copper-plated via on the main circuit board.

11. The inductor structure according to claim 1, wherein each of the first upper lead-out terminals is electrically connected to at least two switch devices, and each of the first lower lead-out terminals is electrically connected to at least one output terminal.

12. The inductor structure according to claim 1, wherein a current direction of the M first metal conductors is opposite to a current direction of the N second metal conductors.

13. The inductor structure according to claim 1, wherein the magnetic core is made of ferrite or soft magnetic materials.

14. A power module, comprising:
an inductor structure, comprising:
a magnetic core, comprising an upper surface and a lower surface arranged opposite to each other;
M first metal conductors disposed in the magnetic core, wherein the M first metal conductors pass through the magnetic core, and each of the M first metal conductors forms a first upper lead-out terminal on the upper surface and a first lower lead-out terminal on the lower surface, wherein each of the M first metal conductors is configured to form a winding; and
N second metal conductors disposed in the magnetic core, wherein the N second metal conductors pass through the magnetic core, and each of the N second metal conductors forms a second upper lead-out terminal on the upper surface and a second lower lead-out terminal on the lower surface, wherein the second upper lead-out terminals and the second lower lead-out terminals are at a common potential;
wherein the M first metal conductors and the N second metal conductors are arranged alternately in a uniformly spaced matrix, wherein a distance between each two adjacent first metal conductors is greater than a distance between each of the M first metal conductors and a corresponding adjacent second metal conductor, M and N are integers, and M is at least 2 and N is at least 2;
a plurality of switch devices, disposed on the upper surface, wherein the plurality of switch devices are electrically connected to the first upper lead-out terminals and the second upper lead-out terminals; and
a bottom circuit board, comprising a ground terminal and an output terminal, wherein the first lower lead-out terminal is electrically connected to the output terminal, and the second lower lead-out terminal is electrically connected to the ground terminal.

15. The power module according to claim 14, wherein the M first metal conductors and the N second metal conductors vertically extend from the upper surface to the lower surface, wherein the M first metal conductors and the N second metal conductors are metal pillars with an identical structure.

16. The power module according to claim 14, wherein the N second metal conductors are directly electrically connected on the upper surface or the lower surface by shorting.

17. The power module according to claim 14, wherein the power module further comprises an upper circuit board and a lower circuit board, wherein the upper circuit board is disposed above the inductor structure and electrically connected to the inductor structure, the lower circuit board is disposed below the inductor structure and electrically connected to the inductor structure, and the N second metal conductors are electrically connected to each other through wiring traces or copper-plated vias of the upper circuit board and the lower circuit board.

18. The power module according to claim 14, wherein the power module further comprises a main circuit board, the magnetic core is disposed in the main circuit board, and the N second metal conductors are electrically connected to each other through wiring traces or copper-plated vias of the main circuit board.

19. The power module according to claim 18, wherein the main circuit board comprises a top surface and a bottom surface, the top surface is spatially corresponding to the upper surface, the bottom surface is spatially corresponding to the lower surface, the M first metal conductors and the N second metal conductors vertically extend from the upper surface to the lower surface, each of the first upper lead-out terminals forms a first upper soldering pad on the top surface through a copper-plated via, each of the first lower lead-out terminals forms a first lower soldering pad on the bottom surface through a copper-plated via, each of the second upper lead-out terminals forms a second upper soldering pad on the top surface through a copper-plated via, each of the second lower lead-out terminals forms a second lower soldering pad on the bottom surface through a copper-plated via, the first upper soldering pad and the second upper soldering pad are electrically connected to a switch device, and the first lower soldering pad and the second lower soldering pad are electrically connected to the bottom circuit board.

20. The power module according to claim 14, wherein a plurality of the windings are connected in parallel with each other.

21. The power module according to claim 14, wherein the power module further comprises a plurality of input capacitors disposed on the upper surface and electrically connected to the plurality of switch devices.

22. The power module according to claim 14, wherein the power module further comprises a plurality of output capacitors and/or a plurality of loads disposed between the lower surface and the bottom circuit board, and the plurality of output capacitors and/or the plurality of loads are electrically connected to the bottom circuit board.

23. The power module according to claim 14, wherein a current direction of the M first metal conductors is opposite to a current direction of the N second metal conductors.

24. The power module according to claim 14, wherein the power module further comprises a plurality of solder balls disposed on a surface of the bottom circuit board away from the inductor structure.

25. The power module according to claim 24, wherein the bottom circuit board is electrically connected to a load, a motherboard or a signal circuit through the surface with the plurality of solder balls disposed thereon.
